(19) United States
(12) Patent Application Publication
(10) Pub. No.: US 2021/0206292 A1
(43) Pub. Date: Jul. 8, 2021

(54) TEMPERATURE-CONTROL ELEMENT WITH SORPTION MATERIAL, IN PARTICULAR FOR CONTROLLING THE TEMPERATURE OF A BATTERY CELL UNIT OF A MOTOR VEHICLE

(71) Applicants: FAHRENHEIT GMBH, München (DE); VOLKSWAGEN AKTIENGESELLSCHAFT, Wolfsburg (DE)

(72) Inventors: Bernd Beyer, Braunschweig (DE); Walter Mittelbach, Freiburg (DE); Andreas Gähme, Wedemark (DE); Charles Peurois, München (DE)

(21) Appl. No.: 17/263,214

(22) PCT Filed: Jul. 25, 2019
(86) PCT No.: PCT/EP2019/070010

§ 371 Date: Jan. 26, 2021

(30) Foreign Application Priority Data
Jul. 27, 2018 (DE) 10 2018 118 177.9

(51) Int. Cl. B60L 58/26; B60H 1/00; B60H 1/14

(52) U.S. Cl. CPC B60L 58/26; B60H 1/00385; B60L 2270/46; B60H 1/143; B60H 1/00278

(57) ABSTRACT

The invention provides a temperature-control element (5) with two covering plates (8) which are arranged at a distance from one another and delimit an intermediate space within which a supporting structure (23) is arranged, said supporting structure keeping the covering plates (8) at a distance from one another, wherein a sorption material (7) which makes contact with the covering plates (8) and the supporting structure (23) is additionally accommodated in the intermediate space. A temperature-control element (5) of this kind allows particularly good transfer of thermal energy between the sorption material (7) and the covering plates (8) by way of the supporting structure (23) not only serving to mechanically connect the covering plates (8) and therefore provide structural strength to the temperature-control element (5) but also causing a transfer of thermal energy between the sorption material (7) and the covering plates (8). As a result, a temperature-control element (5) according to the invention is advantageously also suitable for directly controlling the temperature of, for example, one or more battery cells of a battery cell unit, for example of a traction battery of an electrified motor vehicle.

The invention relates to a temperature-control element with sorption material, in particular for controlling the temperature of a battery cell unit of a motor vehicle. The invention furthermore relates to a battery cell unit with such a temperature-control element, a temperature-control system with such a battery cell unit as well as a motor vehicle with such a temperature-control system.

For operating electrified vehicles such as, for example, battery-powered motor vehicles (BEV) or hybrid vehicles (HEV or PHEV), powerful (traction) batteries are used so as to supply an electric traction motor of the vehicle with electric power. Such traction batteries which may be formed, for example, as lithium-ion batteries, are temperature-sensitive. At relatively low temperatures, these have only a restricted storage capacity which has a correspondingly negative effect with respect to a travel range based on a drive by means of the electric traction motor. Relatively high temperatures, in contrast, lead to a comparatively rapid ageing of the batteries likewise involving a permanent restriction of the storage capacity already after a relatively short duration of use.

To avoid or at least reduce these problems, it may be provided for the traction batteries of electrified motor vehicles to be temperature-controlled so as to keep their temperatures within a defined temperature range at least during operation of the motor vehicle. For such a temperature-control of traction batteries, these may be integrated in a cooling system of the motor vehicle, wherein an additional heating device may be provided so as to be able to cool as well as heat the traction battery. Such a kind of temperature-control of a traction battery requires relatively high electric power to be provided over possibly a relatively long period of time. If the motor vehicle in this case is not connected to an external electrical energy supply, this electric power must be taken from the traction battery. This results in a reduced charging state of the traction battery having a correspondingly negative effect upon the travel range of the motor vehicle.

These problems may be reduced through the use of a sorption unit for controlling the temperature of a traction battery of a motor vehicle, such as this is known from DE 10 2012 012 820A1, DE 10 2015 204 678 A1 or DE 10 2015 204 667 A1, for example.

Such a sorption unit comprises a sorption device having a sorption material that can absorb or adsorb a process medium which can be present as a sorption agent in particular in a gaseous form, wherein thermal energy is released. Such a sorption unit furthermore comprises an evaporator/condenser device hereinafter designated as a phase variator, in which the process medium, for example water, either can be evaporated, whereby it can be absorbed or adsorbed by the sorption material of the sorption device, or in which the process medium condenses, after having been desorbed from the sorption material under heat supply, while taking up thermal energy.

The invention was based on the task of showing a possibility to control the temperature of a (traction) battery of a motor vehicle in an advantageous manner.

This task is solved by means of a temperature-control element according to claim 1. A battery cell unit with such a temperature-control element, a temperature-control system with such a battery cell unit, and a motor vehicle with such a temperature-control system are the subject matters of claims 10, 12 and 14. Advantageous configuration embodiments of the temperature-control element according to the invention, the battery cell unit according to the invention, the temperature-control system according to the invention and the motor vehicle according to the invention are the subject matters of the further claims and/or will result from the description of the invention hereinafter.

According to the invention, a temperature-control element is provided with two covering plates arranged at a distance from one another, which delimit an intermediate space, within which a supporting structure is arranged, said supporting structure keeping the covering plates at a distance from one another, wherein a sorption material is additionally accommodated in the intermediate space which makes contact with the covering plates and the supporting structure at least in sections, preferably if possible over the whole surface. Such a temperature-control element according to the invention allows particularly good transfer of thermal energy between the sorption material and the covering plates by way of the supporting structure not only serving to mechanically interconnect the covering plates (at least with respect to a (pressure) load of the covering plates toward one another) and therefore provide structural strength to the temperature-control element but also causing a transfer of thermal energy between the sorption material and the covering plates. As a result, a temperature-control element according to the invention is advantageously suitable for directly controlling the temperature of, for example, one or more battery cells of a battery cell unit according to the invention.

Such a battery cell unit according to the invention comprises at least one battery cell, i.e. a storage element for electrical energy, and at least one temperature-control element according to the invention resting directly or indirectly against the battery cell with at least one of its covering plates. The temperature-control element or a plurality of temperature-control elements according to the invention may in this case be integrated in particular in a housing surrounding the at least one battery cell, and may in this case preferably even form a portion thereof. Complementarily or alternatively, a temperature-control element according to the invention may (respectively) be arranged between two battery cells of the battery cell unit, whereby in case of still compact dimensions of the battery cell unit, a particularly advantageous, since ideally uniform cooling of the individual battery cell(s) can be achieved.

In order to basically enable an advantageous heat transfer from a temperature-control element according to the invention, for example, to one or more battery cells of a battery cell unit according to the invention, and in addition, in order to realize an advantageous and in particular space-saving integration of one or more of such temperature-control elements into a battery cell unit according to the invention, it should preferably be provided for the height of a temperature-control element according to the invention defined by the thickness of the covering plates and by the distance between the covering plates to be significantly smaller than the length and width. It may in particular be provided for length and width each being ten times, preferably fifty times, particularly preferred hundred time the height.

The temperature control of a battery cell unit according to the invention or of the individual battery cell(s) thereof may then be performed by integrating one or more battery cell unit(s) according to the invention into a temperature-control system according to the invention, in which the intermediate space of the temperature-control element(s) (each) is connected to a phase variator via a control valve such that, when the control valve is opened, a process medium can flow over in a gaseous state between the sorption material arranged within the intermediate space of the associated temperature-control element and the phase variator. If the gaseous process medium, after having been evaporated within the phase variator by supply of thermal energy, flows to the sorption material of the one or more temperature-control elements of a battery cell unit according to the invention, it will be absorbed or adsorbed by the sorption material while releasing thermal energy. Thereby, the battery cell unit and in particular its battery cell(s) can be heated, for example, for being pre-heated after or for a startup procedure at ambient temperatures that are relatively low. In a subsequent operation of the battery cell unit, their battery cells will produce waste heat which can be utilized to desorb the sorption material of the one or more temperature-control elements of a battery cell unit according to the invention, which then will flow to the phase variator when the control valve is opened, where it condenses by correspondingly cooling the phase variator and thus the gaseous process medium while releasing thermal energy. The thermal energy required for the desorption of the process medium from the sorption material thereby is discharged from the battery cell unit, the latter being cooled in this way.

The phase variator preferably can be connected to a refrigerant circuit of a refrigerator of the temperature-control system, thus enabling the phase variator to be applied with relatively cold refrigerant, so as to guarantee that the process medium safely condenses at the phase variator. The refrigerator which can in particular comprise at least a condenser, an evaporator and a compressor, may in particular be provided as an air conditioning system for a motor vehicle according to the invention which basically comprises at least a temperature-control system according to the invention. For this purpose, the refrigerator can comprise an air conditioning heat exchanger which is in particular provided for the temperature-control and in particular cooling of air to be supplied to an interior space of the motor vehicle. For this purpose, the evaporator of the refrigerator as an air conditioning exchanger may in particular also be flown through by air provided for air conditioning an interior space of the motor vehicle, in addition to the refrigerant, whereby thermal energy can be withdrawn from this air which will be utilized within the evaporator for evaporating the refrigerant conducted therethrough.

Complementarily or alternatively, there is also the possibility of connecting the phase variator of a temperature-control system according to the invention to a cooling system, in particular a cooling system of a motor vehicle according to the invention. Such a cooling system is at least characterized in that, by means of a cooling medium flowing therein, thermal energy can be dissipated to ambient air via a cooling medium cooler. Unlike in a refrigerator (with the cooling medium flowing therein), a phase change of the cooling medium is not performed in this case.

In order to realize a particularly preferred transfer of thermal energy between the covering plates and the sorption material it may preferably be provided for the covering plates and the supporting structure to be formed at least in sections, preferably completely, from a material with good thermal conductivity, in particular from one or more metals, for example aluminum. A configuration from metal(s) furthermore has the advantages of a cost-efficient producibility and a good structural load-bearing capacity.

According to a preferred configuration embodiment of a temperature-control element according to the invention, it may be provided for the or at least one of the covering plates and/or the supporting structure to be coated with the sorption material at least partially on that wall surfaces with which these delimit the intermediate space or are arranged within the intermediate space. At the corresponding wall surfaces of the covering plate(s) and/or the supporting structure, an inherently stable layer is correspondingly adhesively bonded consisting at least partially, preferably completely of the sorption material. The corresponding coatings may in this case preferably be formed to be relatively thin (for example, between 0.01 mm and 0.2 mm in a direct coating and up to several millimeters when already dimensionally stable coating layers are applied (in particular adhesively bonded)), so that it can be achieved, on the one hand, that such a temperature-control element according to the invention is relatively compact, whereby it is particularly suitable for cooling a battery cell unit. On the other hand, by combining relatively thin layers of the sorption material having a large-scale contact with the heat-conducting structure of the temperature-control element, i.e. with at least the covering plates and the supporting structure, possibly also with a side wall surrounding the covering plates and circumferentially delimiting the intermediate space, an advantageous heat transfer between the sorption material and the heat-conducting structure of the temperature-control element can be achieved. The relatively thin layers in particular allow the frequently relatively poor thermal conductivity of the sorption material itself to have only low negative effects upon this heat transfer.

If necessary, the material structure of the sorption material, from which the layers are formed, may be so compact that a throughflow of the gaseous process medium through this material structure is not or only possible to a low extent. In order to nevertheless enable a possibly full-surface contact between the process medium and the sorption material, it should preferably then be provided for the layers formed by the coating of the covering plate(s) and/or the supporting structure, to constructively form or delimit one or more flow channels, which ensure(s) a throughflow through the whole intermediate space as extensive as possible and thus a contact between the process medium and the sorption material as large-scale as possible. When the material structure of the sorption material is sufficiently large-pored, such constructively formed flow channels may also be dispensed with, if need be.

Alternatively, or complementarily to a coating of the cover plate(s) and/or the supporting structure with the sorption material, there is also the possibility to preferably fill as extensively as possible the free spaces left free from the supporting structure within the intermediate space with a filling of the sorption material and/or with solid mold bodies of the sorption material, which are formed to be large-pored and/or having flow channels.

So as to ensure a heat transfer and an energy storage capacity between the covering plates and the sorption material as good as possible, the supporting structure should be formed as large-scale as possible, which allows a correspondingly large-scale contact with the sorption material to be achieved. For this purpose, the supporting structure may in particular comprise a corrugated sheet metal structure and/or a foam structure and/or a nonwoven fabric structure or be formed as such a structure. In these cases, the supporting structure consequently is formed by one or several components differing from the covering plates, wherein the supporting structure and the covering plates, in the course of producing a corresponding temperature-control element according to the invention can be fixedly interconnected (in a form-fit manner, in a force-fit manner or in a substance-fit manner, e.g. by soldering). Complementarily or alternatively, however, there is also the possibility of forming the supporting structure from projections of at least one of the covering layers, which (each) contact the other covering plate, in particular corresponding opposite projections of the other covering plate, wherein the covering plates may be fixedly interconnected at these contact points.

If the supporting structure of a temperature-control element according to the invention has a corrugated sheet metal structure, it may further preferably be provided for a plurality of channels running in parallel to one another and extending along a longitudinal extension of the sheet metal structure to be formed by it. The channels may in this case furthermore preferably (preferably uninterruptedly) extend over the entire longitudinal extension of the sheet metal structure. Such a corrugated sheet metal structure can be produced in a relatively simple and thus cost-effective manner, on the one hand, and has a relatively good supporting function for the two covering plates, on the other.

It may also be provided according to a preferred further development of a corresponding temperature-control element according to the invention for such a corrugated sheet metal structure to be subdivided along the longitudinal extension into a plurality of strip-shaped portions extending in a transverse direction, wherein the channels of adjacent portions are offset from one another in the transverse direction. Such a configuration of the supporting structure of a temperature-control element according to the invention can be characterized by a particularly advantageous supporting function for the two covering plates.

It may be provided for a further improvement of the heat transfer from/to the sorption material for a corrugated sheet metal structure to have a plurality of wings extending from this corrugated sheet metal structure, which may also be formed in the form of cuts of the sheet metal structure itself by cuts generated at least by two adjacent sides, so that the corrugated sheet metal structure forms corresponding through-openings with wings each extending from one side of the through-openings (a so-called “louvering”).

Within the intermediate space of a temperature-control element according to the invention, furthermore at least one media channel delimited by the intermediate space may preferably run. This media channel can serve to conduct a cooling medium that is not intended to have any direct contact with the sorption material and the remaining components of the temperature-control element. The media channel is in this case in particular connectable to a coiling system, in particular a cooling system of a motor vehicle according to the invention. This enables, for example, a battery cell unit according to the invention to be cooled only temporarily, in particular relatively briefly by means of a temperature-control element according to the invention as part of a sorption unit of a temperature-control system according to the invention, whereas a cooling of longer duration is realized by the temperature-control element as part of the cooling system. So as to realize in this case an advantageous heat transfer from the battery cells or the battery cells contacting the temperature-control element via the covering plates and, if necessary, also via the supporting structure, to the cooling medium flowing within the media channel, it should preferably be provided for the media channel to be arranged directly adjacent to the covering plate(s) and/or the supporting structure, or integrated therein. A transfer of thermal energy also via the frequently relatively poorly heat-conducting sorption material can thereby be avoided.

The temperature-control element according to the invention may furthermore comprise an electrical heating element, whereby heating of, for example, a battery cell of a battery cell unit according to the invention is also enabled in case of requirement when the process medium has been substantially completely absorbed or absorbed by the sorption material, and therefore thermal energy cannot be released at least temporarily by a corresponding absorption or adsorption.

The motor vehicle according to the invention may in particular be a wheel-based and not rail-based motor vehicle (preferably a passenger car or a lorry).

The indefinite articles (“a”, “an”, “one”), in particular in the claims and in the description generally explaining the claims, are to be understood as such and not as numerals. Components correspondingly concretized therewith thus are to be understood as being present at least once and can be present several times.

The invention will be explained in more detail below on the basis of exemplary configurations illustrated in the drawings. In the drawings, shown are in a simplified representation respectively:

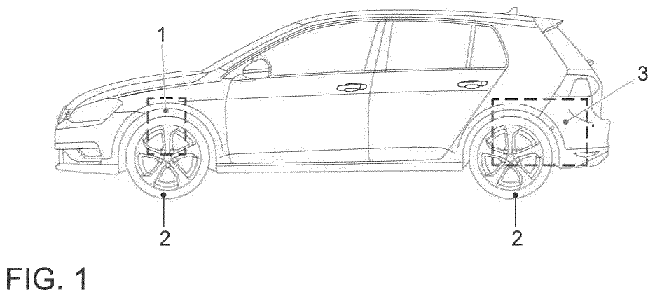

FIG. 1: a motor vehicle according to the invention;

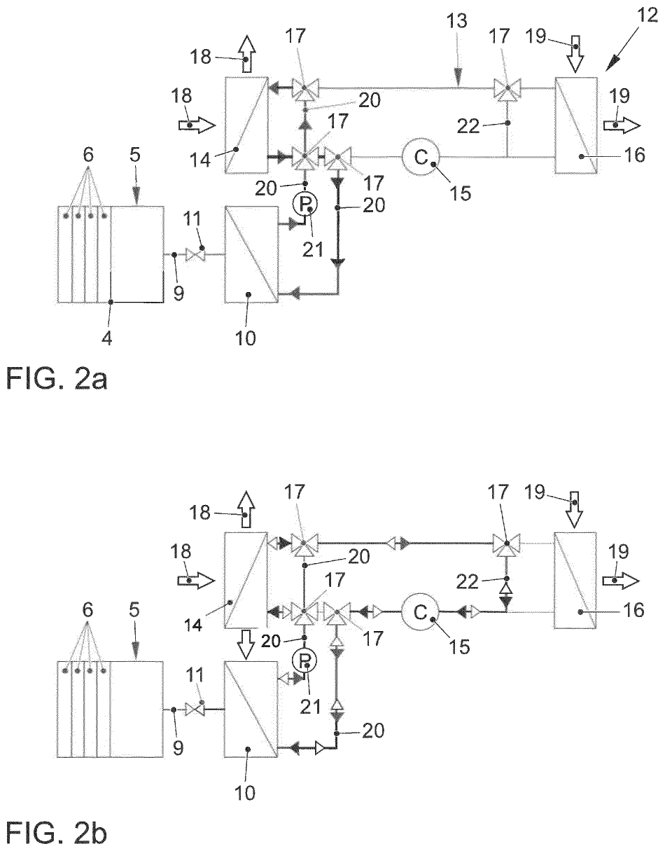

FIG. 2a: a temperature-control system according to the invention in a first operative state;

FIG. 2b: the temperature-control system in a second and a third operative state;

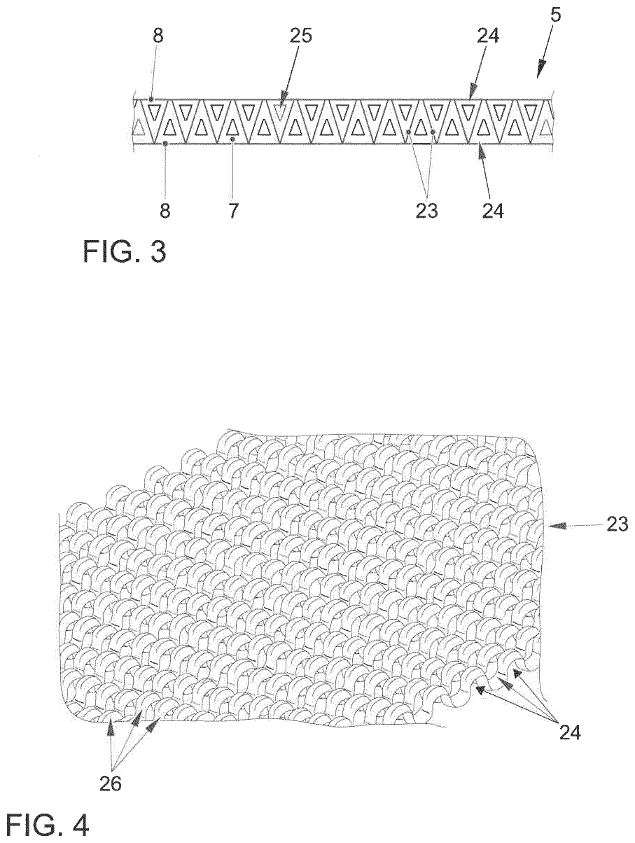

FIG. 3: a cross-section through a temperature-control element according to the invention in accordance with a form of configuration;

FIG. 4: an alternative supporting structure for a temperature-control element according to FIG. 3 in a perspective representation;

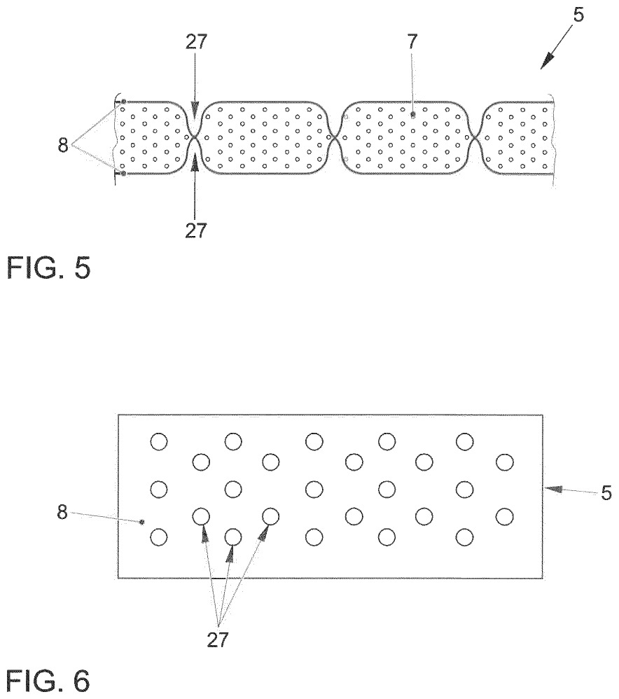

FIG. 5: a cross-section through a portion of a temperature-control element according to the invention in accordance with a further form of configuration; and

FIG. 6 a top view of the temperature-control element according to FIG. 5.

FIG. 1 shows a motor vehicle according to the invention in a simplified representation. The motor vehicle is formed to be electrified and accordingly comprises at least one electrical traction motor 1, the driving power of which can be transferred to driven wheels 2 of the motor vehicle. The motor vehicle may in this case be formed as a battery-powered motor vehicle (BEV). For generating the travel driving power, it comprises in this case exclusively the one or more electrical traction motors 1 as well as a traction battery 3, which is inter alia provided for providing the electrical power required for driving the one or more traction motors 1. Alternatively, the motor vehicle may also be a hybrid vehicle. In this case, the motor vehicle moreover comprises an internal combustion engine (not shown), which is likewise provided to generate driving power at least temporarily, which will be transferred to the driven wheels of the motor vehicle. The hybrid vehicle may in this case be realized both in a configuration as a “simple” hybrid vehicle (HEV), in which the traction battery 3 which is usually dimensioned to be relatively small, is exclusively chargeable by generative utilization of the traction motor 1 or another generator, and also in a configuration as a so-called plug-in hybrid vehicle (PHEV), in which the traction battery 3 is also chargeable by connecting it to an external electrical energy source.

Both in charging the traction battery 3 and also when high electrical power is withdrawn from the traction battery 3, it can produce waste heat to a considerable extent, which needs to be dissipated in order to prevent the traction battery 3 from overheating. It should be ensured at the same time that the temperatures of the traction battery 3 will not fall below a defined lower threshold value, in order to avoid a reduction of the electrical storage capacity coming along with such relatively low temperatures. In order to achieve this, the traction battery 3 is integrated in a temperature-control system according to the invention. Such a temperature-control system is shown in FIG. 2 in a possible form of configuration.

The traction battery 3 formed as a battery cell unit according to the invention comprises in the temperature-control system according to FIG. 2 a plurality of battery cells 6, which are arranged electrically interconnected within a housing 4. A housing wall of this housing 4 has a temperature-control element according to the invention associated to it, wherein the temperature-control element 5 itself preferably forms this housing wall. If required, it may be provided for all of or at least a plurality of the housing walls of the battery cell unit 3 to be formed in the form of one or more temperature-control elements 4 according to the invention. Furthermore, one or more temperature-control elements 4 according to the invention may also be arranged between each of two battery cells 6 so as to realize a temperature-control of the battery cells 6 by means of the one or more temperature-control elements 5 which is as uniform as possible as a whole.

The temperature-control element 5 according to the invention comprises a housing within which a sorption material 7, for example zeolite or silica gel is arranged. The housing of the temperature-control element 5 is formed by two covering plates 8 (cf. FIGS. 3 and 5) as well as side walls (not shown). Via a connection line 9, the inner space of the housing accommodating the sorption material 7 is in fluid-conducting connection with a phase variator 10 formed as a heat exchanger. Into the connection line 9, a control valve 11 is integrated in this case, which is drivable by a control device (not shown). By means of the control valve 11, the fluid-conducting connection via the connection line 9 can be released or blocked. The temperature-control element 5 forms a sorption unit in conjunction with the phase variator 10 and the connection line 9 with the control valve 11 integrated therein, by means of which, in a principally controllable manner, thermal energy can be transferred between the sorption material 7 or the temperature-control element 5 (representing a sorption device of the sorption unit) and the phase variator 10 alternately in both directions. By means of the sorption unit, the temperature of the battery cells 6 of the battery cell unit 3 can accordingly be controlled and in this case be cooled or heated, if required.

For cooling the battery cells 6, the sorption unit is operated in a regeneration operation, for example, during a charging process for the traction battery 3 when the motor vehicle is not in operation, i.e. when the traction battery 3 is connected to an external electrical energy supply, wherein waste heat generated during charging of the battery cells, is utilized for the desorption of process medium (e.g. water) previously absorbed or adsorbed by the sorption material 7 of the one or more temperature-control element 5. For this purpose, a temperature control of the sorption material to a temperature of about 25° C. is already sufficient, for example. The battery cells 6 are cooled by this heat transfer to the sorption material 7 and the desorption of the process medium resulting therefrom. The water vapor released due to the desorption flows via the connection line 9 to the phase variator 10 when the control valve 11 is opened. In the phase variator 10, the water vapor condenses due to a cooling by a refrigerant of a refrigerator 12 of the temperature-control system, which likewise flows through the phase variator 10. When flowing through the phase variator 10, the refrigerant may have a temperature of −5° C., for example.

The refrigerator 12 comprises a refrigerant circuit 13, into which a condenser 14, a compressor 15, an evaporator 16 provided as an air conditioning heat exchanger of a motor vehicle according to the invention, as well as a plurality of control valves 11 are integrated. By means of the refrigerator 12, air 19 to be supplied for controlling the temperature of an interior (passenger) space of the motor vehicle can be cooled in case of demand in a known manner, to which purpose the refrigerant circulating within the refrigerant circuit 13 in a gaseous state is compressed by means of the compressor 15. The compressed, gaseous refrigerant subsequently condenses within the condenser 14, wherein the thermal energy released on this occasion is dissipated to ambient air 18. The refrigerant liquefied in this manner is then conveyed to the air conditioning heat exchanger 16, for example, by means of a pump not shown, in which heat exchanger it can relax, whereby the refrigerant is evaporated again, respectively transferred into the gaseous form. The refrigerant withdraws the thermal energy taken up during the evaporation from the air 19 likewise flowing through the air conditioning heat exchanger 16 and provided for air conditioning the interior space of the motor vehicle.

The phase variator 10 is connected to the refrigerant circuit 13 via separate connection lines 20 and three of the four control valves 17 in total. The thermal energy released within the phase variator 10 due to the condensation of the process medium during a regenerative operation of the sorption unit, is dissipated via the refrigerant. In this case, it may be provided for the refrigerant to be conveyed in a circuit by means of a pump 21 integrated into one of the connection lines 20 of the phase variator 20, which circuit otherwise comprises exclusively the phase variator 10 and the condenser 14 (cf. FIG. 2a), the condenser 14 serving in this case merely for re-cooling the refrigerant. A phase change of the refrigerant does not take place in this circuit. This refrigerant circuit correspondingly corresponds functionally to a cooling medium circuit.

Alternatively, the thermal energy released in the phase variator 10 during a regeneration operation of the sorption unit may also be dissipated via a refrigerant supplied within a circuit which additionally comprises a compressor 15. Thereby, the air conditioning heat exchanger 16 may be bypassed by means of a bypass 22 which can be released by means of the third control valve 17 of the refrigerator 12. In this case, the phase variator 10 of the sorption unit replaces the air conditioning heat exchanger 16 as an evaporator of the refrigerator 12. By means of the compressor 15, refrigerant in the gaseous state is then consequently compressed and supplied to the condenser 14, in which it condenses and is therewith liquefied. The liquid refrigerant is then supplied to the phase variator 10 by means of the pump 21, in which it evaporates. The thermal energy required for this evaporating of the refrigerant is thereby withdrawn from the process medium of the sorption unit, whereby it condenses. The corresponding circuit of the refrigerant is illustrated in FIG. 2b in an emphasized way (by arrows without filled-out surfaces).

During operation of the motor vehicle comprising the temperature-control system, it may be provided for the sorption unit to remain unutilized, for which purpose the control valve 11 of the sorption unit is then kept closed. This prevents the process medium from flowing over between the temperature-control element 5 and the phase variator 10. A possibly necessary cooling of the traction battery 3 can then preferably be realized by an additional cooling system of the motor vehicle (not shown), in which a cooling medium is conducted through cooling medium channels (not shown) integrated within the traction battery 3. Thermal energy which had thereby been transferred from the battery cells 6 to the cooling medium is subsequently transferred to ambient air in a cooling medium cooler of the cooling system. In this case, the coiling medium channels may also be integrated preferably into the one or more temperature-control elements 5 of the battery cell unit 3.

If the motor vehicle was not used for a longer period of time and, during this, was subjected to relatively cold ambient temperatures, the traction battery 3 will have a correspondingly low temperature when the motor vehicle is put into service (cold start) again, which results in a considerable restriction of the storage capacities of the battery cells 6. In order to bring the traction battery 3 after such a cold start of the motor vehicle as fast as possible to optimal temperatures with respect to the storage capacity, the sorption unit is then operated in a sorption operation, for which purpose the control valve 11 of the sorption unit is opened and moreover refrigerant is conveyed in a refrigerant circuit according, for example, to FIG. 2a or 2b (with the flow direction being reversed as compared to the regeneration operation (cf. arrows having a filled-out surface); in this case, the condenser 14 of the refrigerator 12 would be operated as an evaporator). Thereby, due to an appropriate configuration of the sorption unit (in particular also because the process medium is exclusively present within the sorption unit as a fluid, and the sorption unit moreover is operated at a negative pressure), the thermal energy which, when flowing through the phase variator 10, passes over from the refrigerant likewise having ambient temperature (for example, 0° C.) to the liquid process medium contained therein, is sufficient for evaporating this process medium, which then flows to the temperature-control element 5 via the connection line 9. The sorption material 7 contained within the temperature-control element 5 then absorbs or adsorbs the gaseous process medium while releasing heat. The thereby released thermal energy is in this case utilized for controlling the temperature of the battery cells 6 or heating the battery cells 6 of the battery cell unit/traction battery 3 to temperatures of about 25° C., for example.

In order to realize a transition of thermal energy as advantageous as possible between the battery cells 6 of the battery cell unit 3 and the sorption material of the one or more temperature-control elements 5, such a temperature-control element 5 comprises two covering plates 8 arranged at a distance from one another, which form an intermediate space within which a supporting structure 23 is arranged. Circumferentially, the intermediate space is enclosed by side walls (not shown). The side walls may in this case be parts of a separate frame, which is sealingly connected (for example, in a substance-fit manner, in particular soldered) to the covering plates 8. Alternatively, the side walls, however, may be formed by angled portions of one or two covering plates. Due to the supporting structure 23, the covering plates 8 are kept at a distance from one another. In the intermediate space between the covering plates 8, the sorption material 7 is moreover accommodated which contacts both the covering plates 8 and the supporting structure 23. The supporting structure 23, on the one hand, serves for the structural strength of the temperature-control element 5, and, on the other, for connecting the partial amounts of the sorption material 7 only contacting the supporting structure 23, to the covering plates 8 in a heat-conducting manner. In order to guarantee a heat conduction which is as good as possible, both the covering plates 8 and the supporting structure 23 are formed from materials of good heat-conductance, for example, aluminum.

The supporting structure 23 of the temperature-control element 5 represented in FIG. 3 is realized as a corrugated (i.e. meandering) sheet metal structure forming a plurality of channels 24 extending along a longitudinal extension (perpendicular to the drawing plane) of the sheet metal structure and running in parallel to one another, wherein the channels 24 extend uninterruptedly over the entire longitudinal extension of the sheet metal structure. The channels correspondingly represent free spaces within the intermediate space wherein the sorption material 7 is accommodated, which are separated from one another.

In the exemplary configuration according to FIG. 3, the sorption material 7 is provided in the form of coatings applied to the wall surfaces of the covering plates 8 and the supporting structure each delimiting the intermediate space. In this case, the layer thicknesses of the coatings of the sorption material are selected such that flow channels 25 are kept free. Due to these flow channels 25, the gaseous process medium of the sorption unit can get into contact with the sorption material 7 over a surface as large as possible.

In order to realize a distribution of the process medium to the individual flow channels 25, a distribution space (not shown) may be provided within the intermediate space delimited by the covering plates 8, into which all of the flow channels 25 open and which is moreover connected to the connection line 9 of the sorption unit.

The supporting structure 23 of a temperature-control element 5 according to FIG. 3 may also be configured in the form of a turbulence plate as illustrated in FIG. 4. Such a turbulence plate as well is a corrugated sheet metal structure forming a plurality of channels 24 extending along a longitudinal extension of the sheet metal structure and running in parallel to one another. In this case, the sheet metal structure is additionally subdivided along the longitudinal extension into a plurality of strip-shaped portions 26 extending in a transverse direction, wherein the channels 24 of adjacent portions 26 are offset from one another in the transverse direction.

FIGS. 5 and 6 show an alternative form of configuration for a temperature-control element 5 according to the invention, in which the supporting structure 23 is formed by the two covering plates 8 themselves, in that these respectively form a plurality of projections 27, wherein the projections 27 of the two covering plates 8 are opposite and contact one another. In this case, the covering plates 8 preferably are fixedly interconnected at these contact points, for example, by corresponding soldering points. Within the intermediate space delimited by the covering plates 8, sorption material 7 in turn is accommodated. This is represented in FIG. 5 by way of example as a bulk. Alternatively, however, a coating of the wall surfaces of the covering plates 8 delimiting the intermediate space (including the projections) with the sorption material 7 may also be provided in the temperature-control element 5 according to FIGS. 5 and 6.

### LIST OF REFERENCE NUMERALS

1 traction motor
2 wheel
3 traction battery/battery cell unit
4 housing of the battery cell unit
5 temperature-control element
6 battery cell
7 sorption material
8 covering plate of the temperature-control element
9 connection line
10 phase variator
11 control valve of the sorption unit
12 refrigerator
13 refrigerant circuit
14 condenser of the refrigerator
15 compressor of the refrigerator
16 air conditioning heat exchanger/evaporator of the refrigerator
17 control valve of the refrigerator
18 ambient air
19 air
20 connection line
21 pump
22 bypass of the refrigerant circuit
23 supporting structure of the temperature-control element
24 channel of the supporting structure
25 flow channel
26 portion of the corrugated sheet metal structure of the supporting structure
27 projection of a covering plate

1. A temperature-control system with a battery cell unit (3) with at least one battery cell (6) and at least one temperature-control element (5) resting against the battery cell (6) with a covering plate (8),
wherein the temperature-control element (5) has two covering plates (8) which are arranged at a distance from one another and form an intermediate space, within which a supporting structure (23) is arranged keeping the covering plates (8) at a distance from one another,
wherein a sorption material (7) which makes contact with the covering plates (8) and the supporting structure (23) is additionally accommodated in the intermediate space,
wherein the intermediate space of the temperature-control element (5) is connected via a control valve (11) to a phase variator (10) such that a process medium in a gaseous state can flow over between the sorption material (7) arranged within the intermediate space of the temperature-control element (5) and the phase variator (10) when the control valve (11) is opened.

2. The temperature-control system according to claim 1, characterized in that the phase variator (10) can be connected to a refrigerant circuit (13) of a refrigerator (12).

3. The temperature-control system according to claim 1, characterized in that the at least one temperature-control element (5) is integrated in a housing (4) surrounding the at least one battery cell (6) and/or is arranged between two battery cells (6).

4. The temperature-control system according to claim 1, characterized in that the covering plates (8) and/or the supporting structure (23) are formed from one or more metals.

5. The temperature-control system according to claim 1, characterized in that the or at least one of the covering plates (8) and/or the supporting structure (23) is/are coated at least partially with the sorption material (7) on the wall surfaces adjacent to the intermediate space.

6. The temperature-control system according to claim 5, characterized in that the coatings delimit one or more flow channels (25).

7. The temperature-control system according to claim 1, characterized in that the supporting structure (23) comprises a corrugated sheet metal structure and/or a foam structure and/or a nonwoven fabric structure and/or projections (27) formed by at least one of the covering plates (8).

8. The temperature-control system according to claim 1, characterized in that the supporting structure (23) comprises a corrugated sheet metal structure forming a plurality of channels (24) extending along a longitudinal extension of the sheet metal structure and running in parallel to one another.

9. The temperature-control system according to claim 8, characterized in that the channels (24) extend over the entire longitudinal extension of the sheet metal structure.

10. The temperature-control system according to claim 8, characterized in that the sheet metal structure is subdivided along the longitudinal extension into a plurality of strip-shapes portions (26) extending in a transverse direction, wherein the channels (24) of adjacent portions are offset in the transverse direction.

11. The temperature-control system according to claim 1, characterized by a media channel delimited by the intermediate space.

12. A motor vehicle with a temperature-control system according to claim 1.

13. The motor vehicle according to claim 12, characterized in that the refrigerator (12) comprises an air conditioning heat exchanger (16) provided for controlling the temperature of air (19) to be supplied to an interior space of the motor vehicle.

14. (canceled)

15. (canceled)
